(19) United States
(12) Patent Application Publication
(10) Pub. No.: US 2008/0195646 A1
(43) Pub. Date: Aug. 14, 2008

(54) SELF-DESCRIBING WEB DATA STORAGE MODEL

(75) Inventors: Henricus Johannes Maria Meijer, Mercer Island, WA (US); Mark B. Shields, Seattle, WA (US); Soumitra Sengupta, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/674,038

(22) Filed: Feb. 12, 2007

(51) Int. Cl. G06F 17/30

(52) U.S. Cl. 707/102; 707/E17.044

(57) ABSTRACT

A type system and query language for interpreting, storing, and communicating data is provided wherein the data is of hierarchical structure. The data is defined according to a web data model and materialized views are provided in conjunction with the available data as well as general hierarchical querying functionality.

### BACKGROUND

Databases are a staple in backend storage for computer applications as they facilitate quick storage/retrieval of large amounts of data and allow for storage of the data based on relational models such that similarly formatted data is stored together. This relational association of data is just one way to organize data storage and happens to be the leading method in the field. Such reliance on this storage format, whether to store contact information, personal financial transactions, corporate profiles, or any imaginable aggregation of similarly formed data, has continually challenged database developers to implement efficient databases while still allowing endless storage capacity.

However, database usage has become more reliant on the retrieval end and less on the storage end. No longer are the days of periodic batch retrievals, such as mass monthly printouts of a company's ledger or working with a database administrator to retrieve desired data; rather today's databases experience exponentially more specifically tuned data retrievals and often times concurrent usage of a database. Managing these retrievals requires automated access to databases according to digitally stored security profiles. Thus, users the world over are allowed to access data from a single database with automated security ensuring only desired accounts access to given data.

As mentioned, relational databases were popular years ago when retrieval use was done by few, because they afforded a large data store, fast data storage, and easy expedient access to reports and queries on like data. In this way, a relational representation of data was most intuitive for the average database user. However, as data access models move toward support of concurrent access of richly defined data by a plurality of users around the world, databases are needed to facilitate faster retrieval and/or access.

As database models have developed, so have data access models in computer programming languages to where today most languages facilitate hierarchical structuring of data. Computers in general have become more hierarchically oriented such that users today almost expect and understand data that is hierarchically formed better than relational formed data. However, databases have remained the same due to their efficient performance and immense capacity. Moreover, other formats for storing data have arisen; for example, extensible markup language (XML) is a hierarchical data definition language used increasingly in modern applications involving some data storage and lookup. As a further example, really simple syndication (RSS) feeds are built from XML and allow for a standardized data storage mechanism such that applications that read and otherwise access the data can be created in varying forms. In this way, the data is self-describing such that a reader need not know the structure of the data at compile time, rather a run-time translation can occur due to the data's hierarchical structure. As computer and communication speeds increase, performance of databases become of less concern and such intuitive data formatting begins to emerge.

As XML becomes more popular along with the hierarchical interpretation of data, relational databases are becoming increasingly difficult to deal with as data requires conversion from the relational format to the hierarchical format. This alone can be an extremely expensive operation rendering the relational database sometimes insufficient for today's applications, especially where the application requires hierarchical interpretation and is read-heavy.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A type system and query language for interpreting, storing, and communicating data are provided wherein hierarchical structure is given to the data, but query functionality found more often in relational databases is retained. This hybrid approach is more effective than XML as it is lightweight and more efficient and logical than relational database storage.

In accordance with one aspect of the disclosure, an interface is provided such that program applications can interact with the interface in order to retrieve and store data according to a web data model. Such programs can communicate with data stores or other program applications in order to facilitate transfer of such data. Data types can be defined according to the web data model which specifies the type as a series of name/value pairs. The data in this way can be self-describing. The values can be primitive values, instances of disparately defined data types, or arrays of either. The values can also be executable function code or representative of different instances of like or dissimilarly defined data types.

In accordance with another aspect of the disclosure, the data is stored according to a top-level entity type such that all data related to an instance of a top-level entity data type can be stored in the same logical partition. This ensures that all related data can be accessed in one partition and facilitates efficient retrieval of such information in this way. Additionally, data of different types can be defined as links in certain disparate instances of other or like defined data types and stored on separate data partitions. Thus, different entities requesting data need not always access the same data partition. In read-heavy systems, this is of great advantage as it can significantly decrease the number of conflicting reads on a single partition.

According to yet another aspect, materialized view functionality can be implemented such that views of data can be created from the data existing in the data store. The view can represent a common query of the data and can be created automatically or by specification of an administrator to improve overall performance. The view allows for all data satisfying the criteria of the query to be gathered and stored in a single place thus mitigating the need to access all partitions for every query of the same criteria. The views can include the desired values as well as links to the top-level entity types for which they relate in order to facilitate access of other related data. Also, a query language can be specified such that the hierarchical data can be queried in hierarchical form.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating accessing web data model structured data from a program application.

FIG. 2 is a diagram that illustrates sample data type definitions pursuant to the web data model.

FIG. 3 is a diagram that illustrates an example of a soft-link in one data type instance to an instance of another in a disparate data partition.

FIG. 4 illustrates an example of a data type defined with other disparate defined data types as values.

FIG. 5 illustrates a representative interface component.

FIG. 6 is a diagram that illustrates a storage scheme for the web data model structured data.

FIG. 7 illustrates an example materialized view in accordance with the claimed subject matter.

FIG. 8 illustrates a diagram of the system operating in conjunction with a relational database.

FIG. 9 is flow chart diagram of a method of receiving a request for web data model structured data.

FIG. 10 is a flow chart diagram of a method of creating and storing a materialized view of data as well as creating a requested sub-view of the materialized view.

FIG. 11 is a flow chart diagram of a method for storing web data model structured data.

FIG. 12 is a schematic block diagram illustrating a suitable operating environment.

FIG. 13 is a schematic block diagram of a sample-computing environment.

### DETAILED DESCRIPTION

A type system and query language are provided according to a web data model where data is stored and communicated in a structured format. An interface component is provided that facilitates interaction with the structured data. The type system structures the data according to a defined data type, wherein data types can be interrelated such that a value of one defined data type can be of a different data type or a different instance of the same data type. Additionally, a query language is provided to interpret hierarchically structured queries and communicate resulting data back to an application that initiated the query. The query language includes a materialized view component that creates views of the data to facilitate more efficient query performance.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

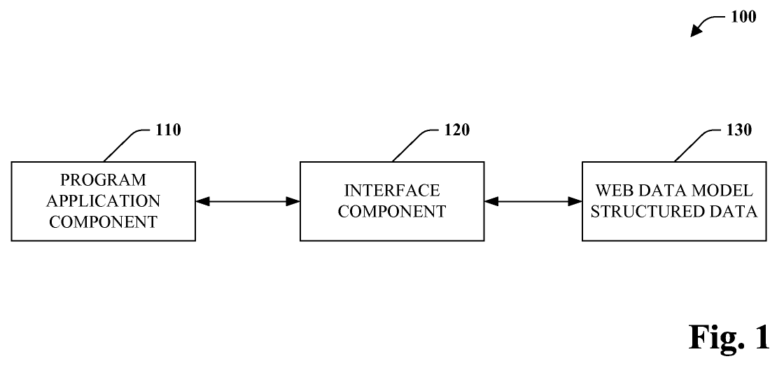

Referring initially to FIG. 1, a data interaction system 100 is illustrated for interacting with data structured according to a web data model (described further infra). The system 100 includes a program application component 110 that makes a request to an interface component 120 for interaction with web data model structured data 130. For example, the request can be for data stored in a database or within another program application. The request can also be to store data in a database or to communicate such to a different program application. Additionally, the request can be to store or retrieve a data type defined in accordance with the web data model, or to run a query on the data.

Upon receiving the request, the interface component 120 processes the request and retrieves the desired web data model structured data 130 if the request was for retrieval, or stores web data model structured data 130 if the request was for storage. The interface component 120 can then return either the requested data and/or a status indicator to indicate success or failure of the requested operation to the program application component 110.

The web data model structured data can be stored in multiple data partitions, as described infra, while still maintaining efficient data retrieval. The storage scheme described herein facilitates this, as related data can be stored in the same partition mitigating the need to stretch partitions for the related data. In this view, where data having a tangential relationship does reside in a different partition, the data model can also provide for links to the data in the separate partition (this functionality described in greater detail infra). Another aim of the data model is that it can be compliant and operable with multiple computer programming languages and databases such as managed code (e.g., CLR, Java . . . ), unmanaged code (e.g., COM, C++ . . . ), relational databases, flat files, markup languages (HTML, XML . . . ), schemas, RSS, and the like.

The web data model can specify parameters to which the data should conform. The parameters can ensure the data stored complies with one aim of the web data model, which is to facilitate easy and efficient data access across the web by way of convenient storage and self-description of the data. It is in this way that program application components 110 can be created without knowledge of exact data format, structure, and location. In this manner, the application is not limited to the particular embodiment of the web data model discussed below, rather it is to be appreciated that the following model is one of many models that could achieve the foregoing ends.

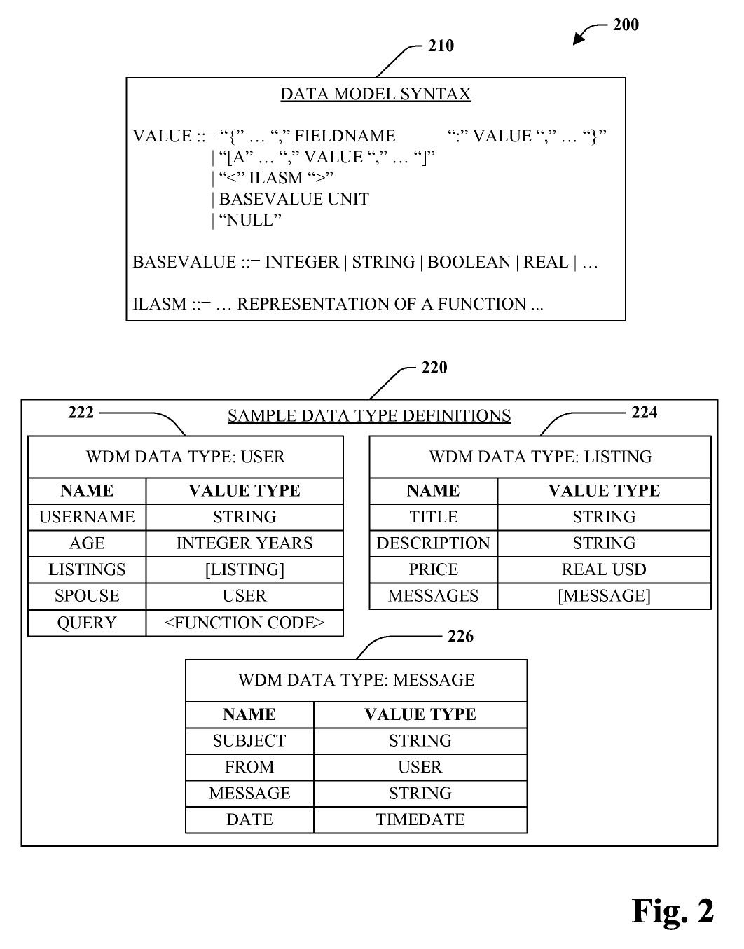

Turning now to FIG. 2, an exemplary embodiment of a web data model 200 is described in detail. Data types in accordance web data model 200 can be defined using data model syntax 210. The definitions comprise name-value pairs for a given data type wherein the values can be defined as follows:

```
value ::=“{” . . .”,” fieldname “:” value “,” . . . “}”
    | “[” . . . “,” value “,” . . . “]”
    | “<” ilasm “>”
    | baseValue unit
    | “null”
baseValue ::= integer | string | boolean | real| ...
ilasm  ::= ... intentional representation of a function . . .
```

Essentially, the value in the pair can be of a primitive type such as integer, string, Boolean, real, and the like. Note also that the base value can be decorated with a unit to provide context thereto. For example, “16” by itself does not mean much unless there is an associated unit or context such as people, minutes, seconds, hours, etc. The value can also be of a defined data type including the type under which it is defined. In addition, the value can be representative of an executable function, or the value can be a null set or null value. The value can further be an array of values corresponding to the above types and the like.

Data types themselves can be defined as follows:

```
decl ::= “type” typeName “=” type
      | “rec” typeName “=” recordType
      | “unit” typeName
      | “unit” typeName “=” unit
type ::= recordType
      | “list” type
      | type “->” type
      | baseType unit
      | type [“?” | “!”]
      | typeName
baseType ::= “Integer”
      | “String”
      | “Boolean”
      | “Real”
      | ...
recordType ::= “{” . . . “,” fieldname “:” type “,” . . . “}”
      | recType “++” recType
      | recType “|” recType
      | typeName
unit ::= unit unit
      | unit “\hat{ }” integer
      | real unitExpr
      | “#”
      | typeName
```

An example of types defined in accordance with the data model is shown at 220. In this example, the system for which the types are created can be one for facilitating interaction with data related to classified advertisement posting. In the example, there are three defined data types: User 222, Listing 224, and Message 226. User 222 is the top-level entity type (e.g. the other types derive from this type) and as will be described in more detail below, all data relating to a single instance of the User 222 type can be stored on one logical partition, including any related instances of Listing 224 and Message 226.

User 222 comprises name value pairs corresponding to a username, age, listings, spouse and query. The username and age are of primitive type and stored as such. Additionally, the age type has a unit specifier, associated with its type, of years. The listings are an array of instances of the Listing 224 data type. All of these instances when stored can be stored on the same partition as the parent instance of User 222. In the context of stored structured data, because they can be stored in the same partition, values of Listing 224 for a given instance of User 222 can be defined as an array of hard-links to the instances within the data store. The spouse entry is of the same type (User 222); this data can be stored on a disparate partition, and thus, a soft-link to this instance is stored in a given instance of User 222. The soft-link points across partitions to the desired instance of User 222 defined as spouse. The last entry of query takes the value of an executable serialized function. Such a function can be used to retrieve additional data, otherwise interact with the data, perform a function external to the system, etc.

Listing 224, like User 222, comprises some primitive values, namely title, description, and price, which again can have a unit specifier of USD (U.S. Dollars). Also, Listing 224 can have an array of instances of type Message 226. Again, hard-links are used to point to the messages since they relate to the Listing 224 which relates to an instance of User 222 which are all stored on the same partition. Message 226 also comprises primitive types of subject, message, and date; however, Message 226 contains a soft-link to the instance of type User 222 that sent the message (defined as ‘FROM’) since that instance can be defined on a disparate logical partition. Thus it is possible to link to instances of the same or disparate data types, and arrays of such types, across multiple data partitions. These links can, in turn, be used to access additional data related to the linked instance. Again, this is merely an example of one possible implementation of data type definitions 220 consistent with the web data model syntax 210.

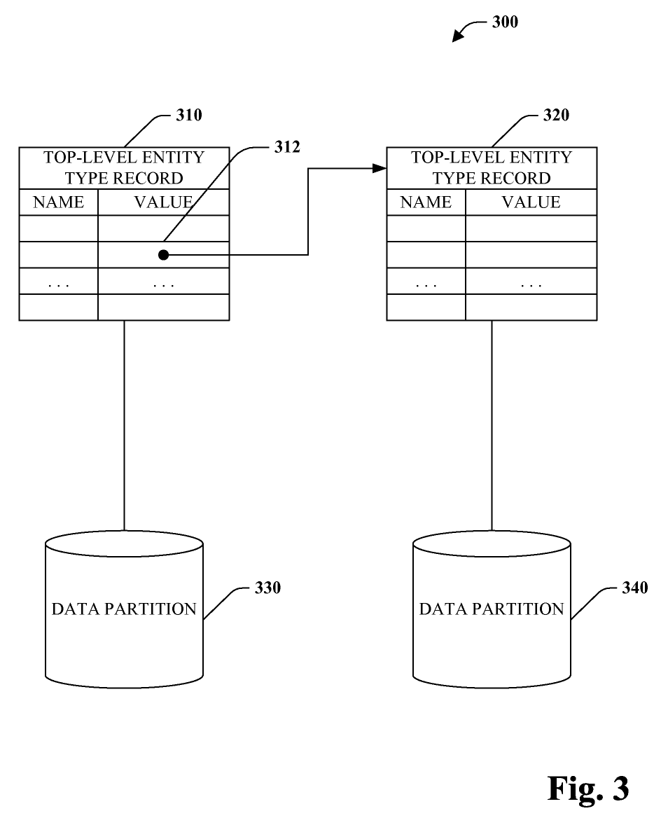

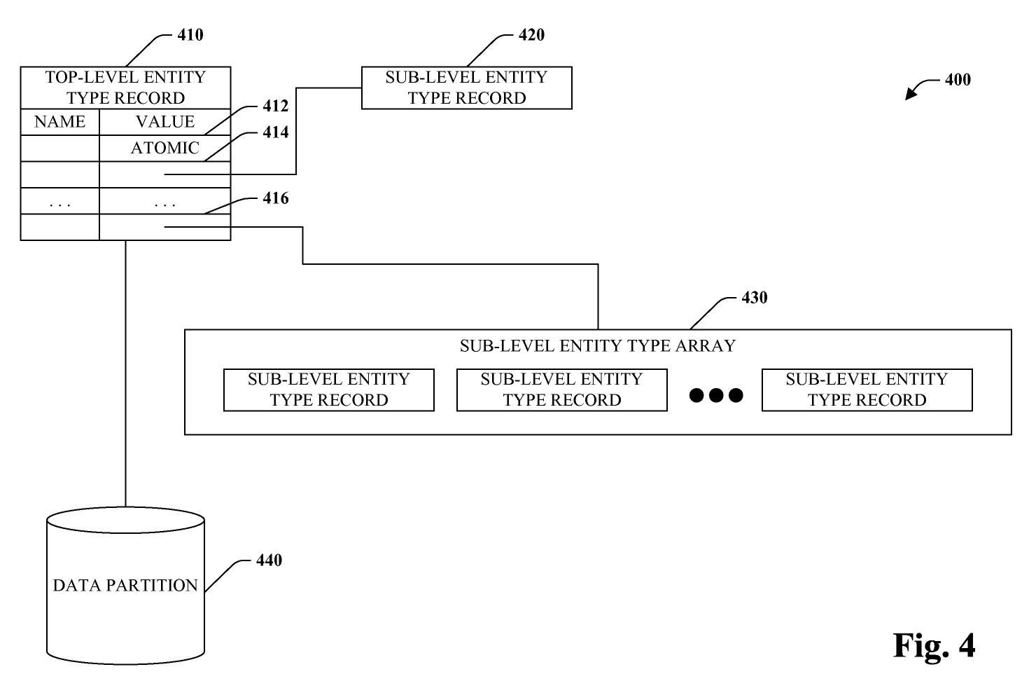

FIGS. 3 and 4 represent examples of data definitions consistent with the web data model. Referring to FIG. 3, data storage scheme 300 in accordance with the web data model is displayed. In this example, there are two instances of a top-level entity data type 310 and 320 resident on disparate data partitions 330 and 340 respectively. Instance 310 comprises a plurality of name/value pairs wherein value 312 is a pointer to the disparate instance 320 of the same data type. The value 312 actually contains information to access instance 320 on the disparate data partition 340 when interacting with the data. This allows all data related to the top-level entity type to be stored on a single partition for efficient access while allowing reference to be made to additional data on disparate partitions. The link is referred to as a soft-link and can contain information necessary to access the disparate partition and also an indicator of where on the partition the data is. Thus, applying the classified advertisement example of FIG. 2 to this example scenario, the types of the two instances 310 and 320 are the User 222 type; specifically 310 can be the example user, and 320 the spouse. They exist on disparate respective partitions 330 and 340; the partitions can exist anywhere including within disparate systems. The example user instance 310 contains a soft-link to the spouse instance 320 for more efficient access (mitigating the need for a query to retrieve the spouse).

Turning to FIG. 4, another data storage scheme example 400 in accordance with the web data model is illustrated. An instance of a top-level entity type is shown at 410 and resides on data partition 440. Instance 410 comprises a plurality of name/value pairs wherein value 412 is of an atomic data type. Value 414 is of a disparate defined sub-level data type 420, and value 416 is an array of instances of a defined sub-level data type 430. All of the data related to the instance 410 of data type is stored together in partition 440 to allow for efficient access of the related data.

Thus, using the classified advertisement example given above in FIG. 2, instance 410 can be of the User 222 type and all related sub-data is stored on the same data partition 440. Then the sub-level entity type 420 can be a disparate defined type wherein only a single related instance is necessary, such as a contact profile for the given user (e.g. containing e-mail address, various instant messenger accounts, etc.). The array of instances of the sub-level data type 430 can be of the Listing 224 type and the instances of the array 430 can further have data structured pursuant to the foregoing description.

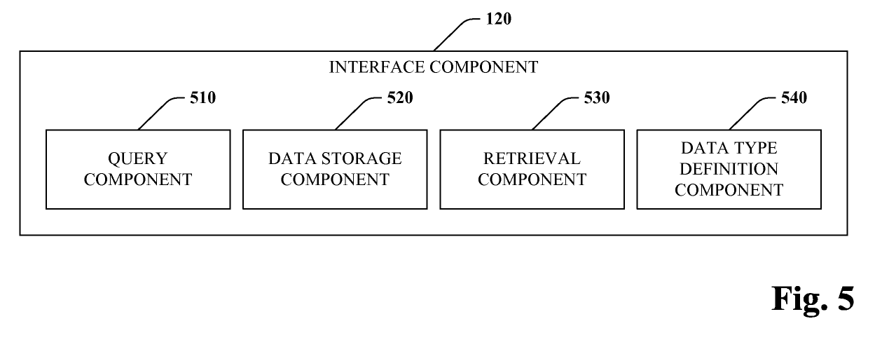

FIG. 5 illustrates a detailed view of the interface component 120 comprising a query component 510 that facilitates querying between a program application and web data model structured data, a data storage component 520 that houses data structured in accordance with a web data model, a retrieval component 530 that accesses data from a data store where the data is housed according to a web data model, and a data type definition component 540 that facilitates definition of data types in accordance with a web data model.

Query component 510 allows a program application to submit a query for data structured according to the web data model. Query expressions can be composed of a number of let and from bindings that range over source collections and introduce names for intermediate values, filter and grouping and aggregation clauses, and an optional sorting clause followed by a projection:

```
query-expression ::= let-clause*
      | from-clause
      | from-let-where-group-clause*
      | [orderby-clause]
      | return-clause
```

From-clauses express a join/Cartesian product of several collections:

from-clause ::= “from” ..., identifier [: type] “in” expression, ...
let-clause ::= “let” ..., identifier [: type] “=” expression, ...

The where clause removes values from a collection that do not match the filter predicate:

where-clause::=“where” expression

The group-by clause partitions the input collection based on the key expressions and then aggregates each such group as specified by the aggregate expression:

group-clause ::= “group” [identifier] “by” ..., identifier = expression, ... _{—}
“aggregates” ..., identifier = aggregate-expression, ...

A number of aggregates can be supported by the query language, including one that calls a user-defined aggregate expressed as an expression that returns an instance of a type that implements the UDA pattern:

```
aggregate-expression ::= “count”
      | “sum” “of” expression
      | “product” “of expression
      | “average” “of” expression
      | “maximum” [expression] “of” expression [“by” expression]
      | “minumum” [expression] “of” expression [“by” expression]
      | “top” expression “of” expression
      | “sample” expression “of” expression
      | “quantile” expression “of” expression
      | “unique” expression “of” expression
      | “collection” “of” expression
      | “some” “satisfies” expression
      | “each” “satisfies” expression
      | “UDA” “of” expression
```

The order by clause takes a number of key expressions used to sort:

orderby-clause::=“orderby” . . . , expression [“ascending”| “descending”], . . .

Finally the return clause computes the final result of the query:

select-clause::=“return” expression

The identifier in the above query language specification can refer to a hierarchical specification of desired data. For instance, in the classified advertisement system example above, an identifier might be User[“Bob”].Listings. It is to be appreciated that other query languages and syntax can be employed in connection with the claimed subject matter.

Once a query is initiated to query component 510, the component 510 can query all values on all relevant partitions, or alternatively, can utilize a stored materialized view of the data. If the requested query is a subset of an available materialized view, the materialized view can be further queried in accordance with the query expression. Materialized views are discussed in greater detail infra.

Data storage component 520 facilitates seamless storage of the structured data. This component is described in further detail infra. Retrieval component 530 responds to data access requests made to the interface component 120 for stored data. The retrieval component retrieves the structured data and transmits it back to the requesting entity. Data type definition component 540 allows for specification and retrieval of defined data types. Thus, a program application can specify a data type, pursuant to the syntax described supra, for data it has submitted for storage or request a data type for data it has retrieved from storage. Additionally, the data can be self-describing.

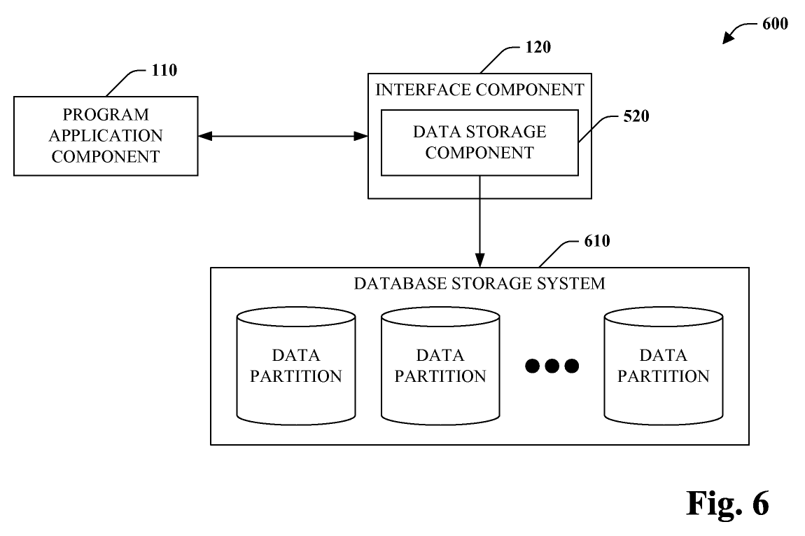

Turning now to FIG. 6, a system for storing web data model structured data is displayed. The system 600 comprises a program application component 110, and interface component 120, which comprises a data storage component 520, and database storage system 610 comprising multiple logical data partitions. The program application component 110, desiring storage of data structured according to the web data model, communicates with the interface component 120. The interface component 120 facilitates communication of the data to the data storage component 520. The data storage component 520 can store the data in a distributed database storage system 610 comprising multiple partitions.

The data storage component 520 can store the data in such a way to facilitate expedient access to the data. One way to achieve such efficiency where reading the data occurs more often than writing the data is to spread the data out amongst multiple partitions. This will alleviate the number of reads on a single partition. Where data is requested in extremely high volume, such a scheme renders more efficient retrieval of data since a number of clients can be trying to access data on the same partition at the same time. Thus, distributing the data along multiple partitions lessens time a client waits for data since the data storage component 520 may not have to access the same partition for each client's request. In this view, the optimal storing scheme is to put each piece of data on a disparate partition to ensure a different partition is used for each request and partitions will only be accessed at the same time where the same data is being requested.

However, this is not the only condition to consider; rather a client may wish to aggregate data related to a given entity and would have to hit all the partitions where such data exists in this scheme. For this reason, finding a middle ground between these two scenarios is optimal. One way to achieve both efficiencies in a data storage system is to store all data related to an instance of a top-level entity type in one partition as mentioned supra, and spread the instances of top-level entity type among multiple partitions. In this way, all data related to a single instance of the top-level type will require accessing only one partition, and only when data need be from a different instance of the top-level type will another partition be accessed.

In this case, the program application component 110 calls the interface component 120 with a request to store some structured data. The interface component 120 passes this information along to the data storage component 520. The data storage component then determines whether the data is related to an instance of a top-level entity type; if so, the data storage component 520 stores the data on the same partition as the top-level entity type and updates the instance of the top-level entity type with a hard-link to the data. If the data is of a top-level entity type, it is newly stored on a desired partition and if it relates to another instance of the same type, a soft-link to the data is placed in the related instance, which can be resident on a disparate partition in the database storage system 610.

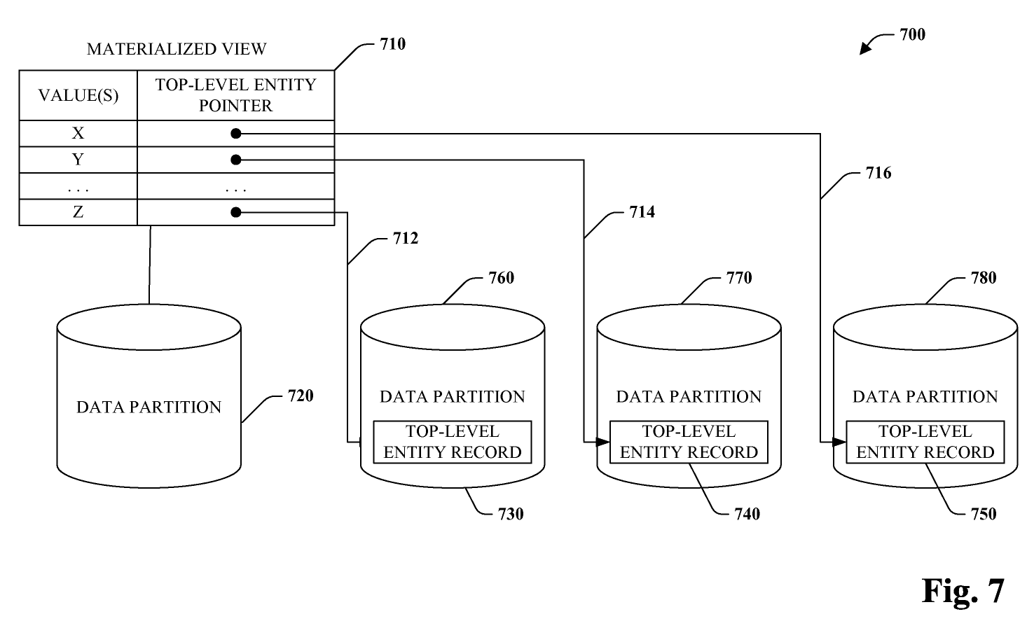

Referring now to FIG. 7, a system 700 for creating materialized views of data is shown. A materialized view is shown at 710 and is stored in data partition 720. The view 710 comprises multiple values satisfying certain criteria, each value can have a pointer 712, 714, 716 to the instance of top-level entity type the value relates to. The instances 730, 740, 750 can be stored in disparate partitions 760, 770, 780 as shown. The materialized view 710 offers a mechanism for aggregating desired values from records spanning multiple partitions 760, 770, 780 in a single entity on a single logical partition 720. This avoids repeatedly running queries across all partitions to retrieve desired data where the query is commonly requested. Like the storage scheme described supra, this facilitates more efficient access as it avoids conflicting reads across multiple partitions where the query is requested simultaneously by a number of clients.

For example, again using the classified advertisement example, top-level entity type instances 730, 740, 750 are of type User 222 and the materialized view 710 is a query for all listings of automobiles. This can be a common query for the system, so the idea of the materialized view 710 in this example is that it always contains the records for all automobiles in the database. It is not necessary to gather the data structures in their entirety for such listings, but since the claimed subject matter provides a linking functionality, the view can contain basic information about the listings, such as make, model, and year of the automobile, along with a link or pointer 712, 714, 716 to the instance of User 222 to which it relates. Then when a program application requests this query, the subject matter claimed herein need only return the materialized view 710 which is much more efficient than querying all data partitions every time the query is requested. Then if subsequent data is requested for a specific entry in the materialized view, the link to the top-level entity type 712, 714, 716 will allow the program application requesting the additional data to only make one other jump to another partition for all data related to that instance.

Thus, more efficient access of the resident data is facilitated through this materialized view functionality. Additionally, materialized views can be used to quickly create subviews such as when a program application is requesting a more specific query than the materialized view offers. For example, in the automobile example given above, if the program application requested all trucks, the subject matter claimed herein can utilize the already existing automobile view and filter it to return only trucks rather than creating an entirely new view only for trucks. Moreover, the materialized views can be created by an administrator or automatically according to artificial intelligence decisions made according to the demand of certain data. In this way, overall system latency can be mitigated by pre-aggregating common queries such that the queries do not need to be run every time they are requested, rather the results of the materialized view can be returned.

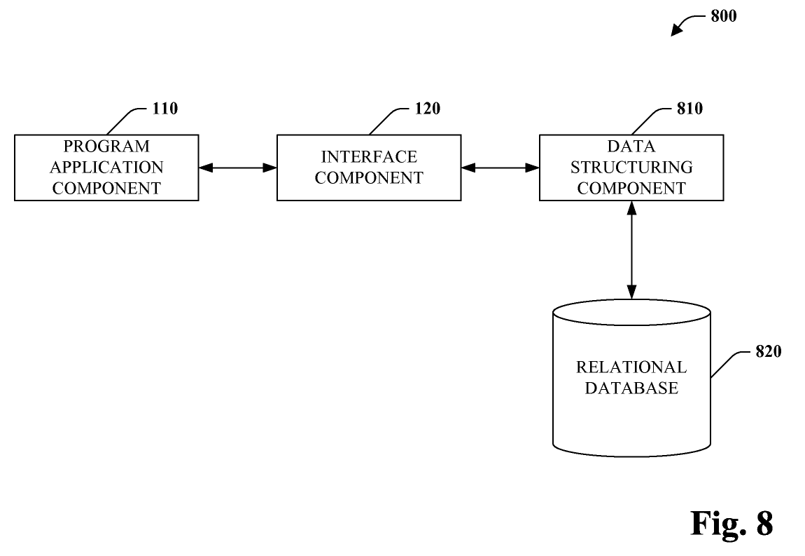

With reference to FIG. 8, a system 800 for operating the claimed subject matter in accordance with a relational database is shown. The system 800 comprises a program application component 110 that makes requests to retrieve and store data, an interface component 120 that fields such requests, a data structuring component 810 that transforms data from a relational structure to a web data model structure and vice versa, and a relational database 820. The program application component 110 can make a request to the interface component 120 to retrieve data. Upon receiving the request, the interface component 120 processes it and makes an appropriate request to the data structuring component 810. The data structuring component 810 then retrieves the data from the relational database 820 and gathers appropriate data type definition(s) for the relational data. The data structuring component 810 formats the relational data to comply with the data type definition(s) according to a web data model. The data is then returned to the interface component 120 making its way to the requesting program application component 110.

The program application component 110 can also make a request to the interface component 120 for storage of web data model structured data. In this scenario, the request is processed by the interface component 120 and sent, along with the data to store, to the data structuring component 810. The data structuring component 810 then formats the data in such a way to store it relationally while retaining enough information to be able to re-form it according to the web data model upon request. One such example can be to create tables according to each data type in the storage request. For example, in the classified advertisement example, tables can be created for the User 222 type, the Listing 224 type, and the Message 226 type. The columns of the table can correspond to the names of the name/value pairs according to the data type definition, and the rows are the values according to the name/value pair for each instance to be stored. Where links exist, they can be a partition ID or some other scheme in order to point to disparately located data. Also, the data type definitions can be stored in the data structuring component 810 and related to a given table of data in the relational database 820. It is to be appreciated that other storage and conversion schemes can be created in accordance with the claimed subject matter. Upon request for data, as discussed supra, the data structuring component 810 can reapply the data type stored to the data requested from the relational database 820.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers. . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

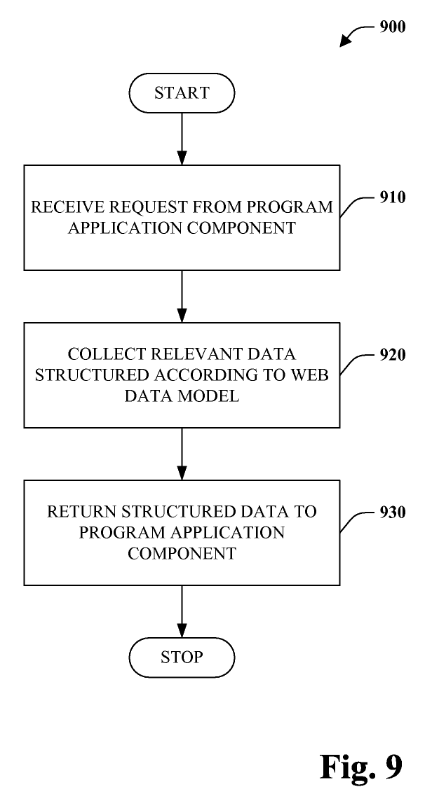

In view of the exemplary systems described sura, methodologies that may be implemented in accordance with the disclosed subject matter will be better appreciated with reference to the flow charts of FIGS. 9-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 9, a method 900 of implementing an interface facilitating transfer of data is illustrated. At reference numeral 910, the interface receives a request for data from a program application component. The request can alternatively be to store data provided by the program application component. The request can be provided in numerous ways, both as a query and/or as a hierarchical dot-notation specification. Also, a request can be provided by attempting to access data that is soft-linked in the existing structure (e.g. trying to access a linked disparate instance of a top-level entity type from an existing instance of that type such as User[“Bob”].Spouse). At numeral 920, the interface collects data relevant to the request by a program application, for instance. The collected data is structured according to a web data model which is inherently understood by the program application. The data can also be self-describing such that no understanding of the underlying structure on the part of the requesting entity is necessary. At reference numeral 930, the structured data is returned to the requesting program application.

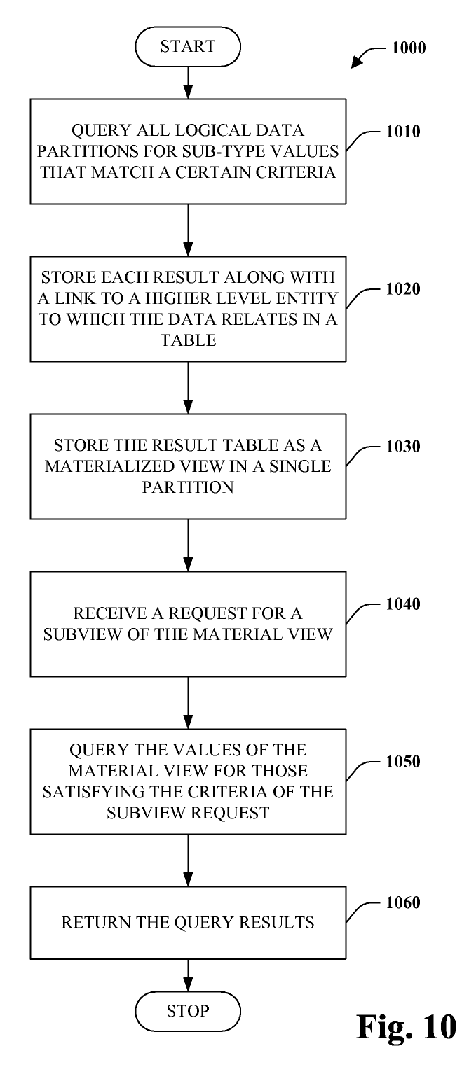

Turning now to FIG. 10, a method 1000 for creating and querying a materialized view is depicted. At numeral 1010, a query is run over all partitions according to specified criteria; the query can specify any desired value or range of values for any value existing in a defined data type. Typically, this can be in accordance with a query syntax such as that provided supra. At 1020, the results are gathered and stored in a table or other object along with the values matching the desired query criteria and a link to the top-level entity type to which the value relates. Storing this link to the top-level entity type instance facilitates more efficient access to related data after the query is returned to the requesting entity. At numeral 1030, the resulting table is stored as an available view in the data storage system and can be used by aspects of the claimed subject matter when requested, or when processing logic decides or infers the view would enhance performance.

At reference numeral 1040, a request for a subview of the materialized view is received. It is to be appreciated that request for the view itself can be received and the materialized view can be returned in its entirety. However, a subview will be returned where the materialized view does not exactly match the desired query. For example, where the materialized view is a superset of the desired data, the view will be further filtered according to the additional criteria. For instance, if the view is for all automobiles in a classified advertisement system and the desired query is for all automobiles in Seattle, a subview can be created such that the materialized view is further filtered according to a city value of Seattle. At number 1050, such filtering occurs and the values of the materialized view are queried for those matching the additional criteria. At 1060, the query results are returned to the requesting entity.

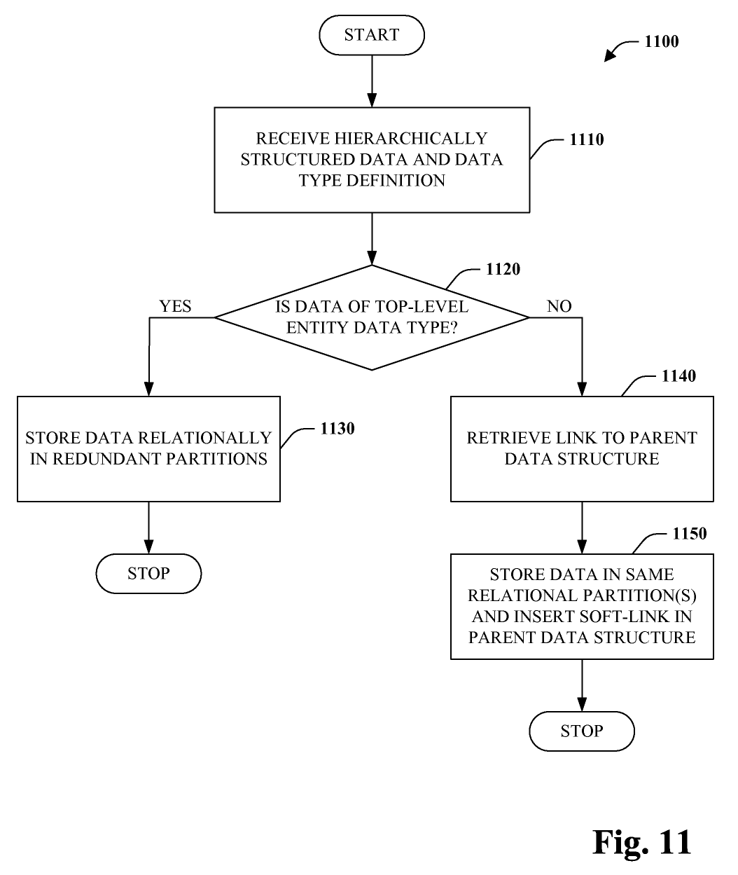

Referring now to FIG. 11, a methodology 1100 for storing hierarchically structured data in a relational database is illustrated. At reference numeral 1110, the hierarchically structured data is received along with the data type definition. At 1120, a determination is made as to whether the data is of a top-level entity type or not. If so, then at 1130, all data according to that instance is stored in a singe relational partition. Also, if the new data is linked to other data related to a disparate instance of the top-level entity type, the link can be placed in the existing data. If the data is not of a top-level entity type, then at 1140, the link to the parent structure is retrieved. At 1150, the data is stored in the same partition as the related top-level entity type and a hard-link is placed in the instance of the top-level entity type to the new data.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

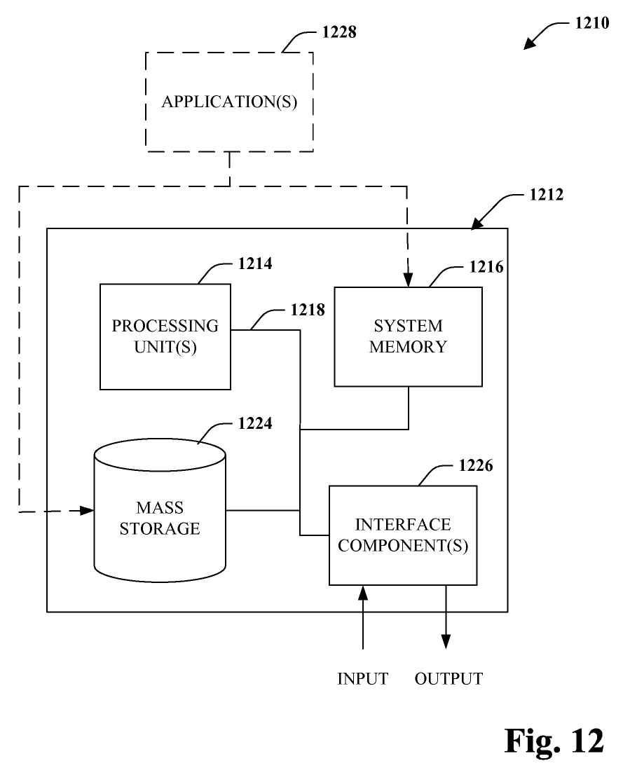

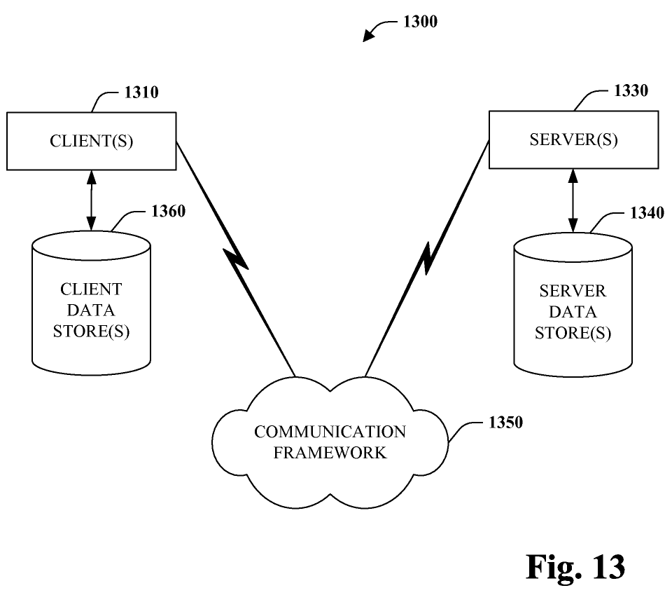

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216 and a system bus 1218. The system bus 1218 couples system components including, but not limited to, the system memory 1216 to the processing unit 1214. The processing unit 1214 can be any of various available microprocessors. It is to be appreciated that dual microprocessors, multi-core and other multiprocessor architectures can be employed as the processing unit 1214.

The system memory 1216 includes volatile and nonvolatile memory. The basic input/output system (BIOS), containing the basic routines to transfer information between elements within the computer 1212, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1212 also includes removable/non-removable, volatile/non-volatile computer storage media. FIG. 12 illustrates, for example, mass storage 1224. Mass storage 1224 includes, but is not limited to, devices like a magnetic or optical disk drive, floppy disk drive, flash memory or memory stick. In addition, mass storage 1224 can include storage media separately or in combination with other storage media.

FIG. 12 provides software application(s) 1228 that act as an intermediary between users and/or other computers and the basic computer resources described in suitable operating environment 1210. Such software application(s) 1228 include one or both of system and application software. System software can include an operating system, which can be stored on mass storage 1224, that acts to control and allocate resources of the computer system 1212. Application software takes advantage of the management of resources by system software through program modules and data stored on either or both of system memory 1216 and mass storage 1224.

The computer 1212 also includes one or more interface components 1226 that are communicatively coupled to the bus 1218 and facilitate interaction with the computer 1212. By way of example, the interface component 1226 can be a port (e.g., serial, parallel, PCMCIA, USB, FireWire . . . ) or an interface card (e.g., sound, video, network . . . ) or the like. The interface component 1226 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1212 to output device(s) via interface component 1226. Output devices can include displays (e.g., CRT, LCD, plasma . . . ), speakers, printers and other computers, among other things.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the aspects of the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. Here, the client(s) 1310 can correspond to program application components and the server(s) 1330 can provide the functionality of the interface and optionally the storage system, as previously described. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

By way of example, a program application component can request web data model structured data (or make other requests such as to store data or a data type specification) from one or more servers 1330 via a client 1310. The server(s) 1330 can obtain the desired data from a data store 1340 (or store the desired data or type) and optionally format the data according to the web data model. Subsequently, other program application components can request access to the same or different data from the server(s) 1330.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A semi-structured data interaction system, comprising:
a program application component; and
an interface component that facilitates interaction between the application component and structurally-typed, semi-structured data organized in accordance with a web data model.

2. The system of claim 1, the interface component comprises a query component that facilitates querying of the data according to a hierarchical query syntax.

3. The system of claim 1, the interface component comprises a data storage component that implements a distributed storage system such that the data is stored on multiple data partitions.

4. The system of claim 3, the data storage component stores data related to an instance of a top-level entity data type in a data partition where the instance resides.

5. The system of claim 1, the interface component comprises a data type definition component that defines a data type in accordance with the web data model.

6. The system of claim 5, the data type comprises at least one name/value pair.

7. The system of claim 6, further comprising a data structuring component that structures data in accordance with the data type.

8. The system of claim 6, the value of the at least one name/value pair is a link to an instance of the same data type resident on a different data partition.

9. The system of claim 6, the value of the at least one name/value pair is of a disparate defined sub-level entity data type.

10. The system of claim 6, the value of the at least one name/value pair is a primitive data type paired with a unit specification.

11. The system of claim 6, the value of the at least one name/value pair is one of at least one name/value pair, a collection or array of values, a null set, or an intentional representation of an executable function.

12. The system of claim 6, the data type further comprising a boolean indicator to represent whether the value is nullable and a boolean indicator to represent whether the value is not null.

13. The system of claim 1, the interface component comprises a data retrieval component that presents requested data, according to the web data model, using atomic values for primitive data, hard-links to reference data from the same partition but of a different data type and soft-links to reference data resident on a different partition.

14. A method for aggregating semi-structured data in a distributed data storage and retrieval system comprising:
storing data on a data partition according to an instance of a top-level entity data type to which the data relates; and
materializing a view of the data by storing values resulting from a query based on at least one criterion along with a link to a related instance of a top-level entity data type.

15. The method of claim 14, the materialized views are automatically created according to a machine learning based determination that defining the view will be beneficial in avoiding overall system latency.

16. The method of claim 14, the at least one criterion relates to a value of a sub-level entity data type.

17. The method of claim 16, further comprising creating a subview of the materialized view based on an additional query of the resulting data values.

18. A computer readable medium having stored thereon a data structure comprising:
one or more name/value pairs, the value of at least one name/value pair is a reference to a different instance of the same data structure located on a different data partition.

19. The data structure of claim 18, the value of at least one name/value pair is one of at least one name/value pair, a collection of values, a null value, an intentional representation of an executable function or a primitive value.

20. The data structure of claim 19, the value of at least one name value pair is a primitive value decorated with a unit specification.
